(19) United States
(12) Patent Application Publication
(10) Pub. No.: US 2025/0036500 A1
(43) Pub. Date: Jan. 30, 2025

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Mitsuhiro ONO, Yokosuka-shi (JP); Masanori ITOH, Kodaira-shi (JP); Takuya YOSHIDA, Higashimurayama-shi (JP); Atsushi MAKITA, Chofu-shi (JP)

(73) Assignee: TOYOTA JIDOSHA KABUSHIKI KAISHA, Toyota-shi (JP)

(21) Appl. No.: 18/774,337

(22) Filed: Jul. 16, 2024

(30) Foreign Application Priority Data
Jul. 25, 2023 (JP) 2023-120626

(51) Int. Cl. G06F 11/00; G06F 11/07

(52) U.S. Cl. CPC G06F 11/008; G06F 11/076

(57) ABSTRACT

An information processing device includes a processor configured to: determine, by using an anomaly detection model, whether an anomaly has occurred in a first system; when determination is made that the anomaly has occurred in the first system, presume whether the anomaly is influenced by a failure in an external system connected to the first system; and when presumption is made that the determined anomaly is influenced by the failure in the external system, update the anomaly detection model to reduce influence of the failure in the external system.

### CROSS-REFERENCE TO RELATED APPLICATION

This application claims priority to Japanese Patent Application No. 2023-120626 filed on Jul. 25, 2023, incorporated herein by reference in its entirety.

### BACKGROUND

### 1. Technical Field

The present disclosure relates to an information processing device, an information processing method, and a non-transitory storage medium related to a failure detection technology.

### 2. Description of Related Art

There are technologies for detecting anomalies that have occurred in information processing systems including communication networks and server devices. In this regard, for example, Japanese Patent No. 7004479 (JP 7004479 B) discloses a method for generating a machine learning model that enables highly accurate anomaly detection.

### SUMMARY

Along with development of machine learning, the use of machine learning models in the field of failure detection is expected to increase.

The present disclosure provides an information processing device, an information processing method, and a non-transitory storage medium that improve the accuracy of failure detection.

An information processing device according to a first aspect of the present disclosure includes a processor configured to: determine, by using an anomaly detection model, whether an anomaly has occurred in a first system; when determination is made that the anomaly has occurred in the first system, presume whether the anomaly is influenced by a failure in an external system connected to the first system; and when presumption is made that the determined anomaly is influenced by the failure in the external system, update the anomaly detection model to reduce influence of the failure in the external system.

An information processing method according to a second aspect of the present disclosure is executed by an information processing device. The information processing method includes: determining, by using an anomaly detection model, whether an anomaly has occurred in a first system; presuming, when determination is made that the anomaly has occurred in the first system, whether the anomaly is influenced by a failure in an external system connected to the first system; and updating, when presumption is made that the determined anomaly is influenced by the failure in the external system, the anomaly detection model to reduce influence of the failure in the external system.

A non-transitory storage medium according to a third aspect of the present disclosure stores instructions that are executable by one or more processors and that cause the one or more processors to perform functions. The functions include: determining, by using an anomaly detection model, whether an anomaly has occurred in a first system; presuming, when determination is made that the anomaly has occurred in the first system, whether the anomaly is influenced by a failure in an external system connected to the first system; and updating, when presumption is made that the determined anomaly is influenced by the failure in the external system, the anomaly detection model to reduce influence of the failure in the external system.

According to the present disclosure, the accuracy of failure detection can be improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic diagram of a data collection system according to a first embodiment;

FIG. 2 shows an example of the hardware configurations of a vehicle and an in-vehicle device;

FIG. 3 shows an example of the hardware configuration of a server device;

FIG. 4 shows an example of the hardware configuration of an anomaly detection device;

FIG. 5 schematically shows the software configuration of the in-vehicle device;

FIG. 6 schematically shows the software configuration of the server device;

FIG. 7 shows an example of measurement data acquired by the anomaly detection device;

FIG. 8 schematically shows the software configuration of the anomaly detection device;

FIG. 9 illustrates an operation of a model generation unit;

FIG. 10 illustrates an operation of a determination unit;

FIG. 11 illustrates an operation of a model update unit;

FIG. 12 is a sequence diagram of processes to be performed by the in-vehicle device, the server device, and the anomaly detection device;

FIG. 13 is a flowchart of a process for generating an anomaly detection model;

FIG. 14 is a flowchart of an anomaly detection process using the anomaly detection model;

FIG. 15 is a flowchart of a process for updating the anomaly detection model; and

FIGS. 16A and 16B illustrate time periods in which failures have occurred.

### DETAILED DESCRIPTION OF EMBODIMENTS

There is a system in which a server device collects sensor data acquired by a plurality of vehicles (probe cars). By collecting pieces of data from the vehicles, various types of information such as the latest traffic jam information can be generated and provided to the vehicles.

There is a technology for determining that an anomaly has occurred in such a data collection system. For example, various measurement values are collected from a communication network and a server device in the system and input to a machine learning model for anomaly determination. Therefore, a score indicating the degree of an anomaly occurring in the system can be obtained. Further, an alert can automatically be issued based on the score.

However, the known technology has a problem in that, even if a failure has occurred in only part of the system, the system as a whole is determined to be anomalous. For example, when a failure has occurred in part of the communication network but the function as a whole is maintained, the anomaly determination continues as long as the failure continues, and other new anomalies that may occur (e.g., hardware failure) cannot be detected. The information processing device according to the present disclosure solves such a problem.

An information processing device according to one aspect of the present disclosure includes a control unit configured to: determine, by using an anomaly detection model, whether an anomaly has occurred in a first system; when determination is made that the anomaly has occurred in the first system, presume whether the anomaly is influenced by a failure in an external system connected to the first system; and when presumption is made that the determined anomaly is influenced by the failure in the external system, update the anomaly detection model to reduce influence of the failure in the external system.

The first system is typically a system that collects and processes data from a plurality of nodes. The first system may include the nodes, a server device that collects data transmitted from the nodes, and a communication network that connects the nodes and the server device. The first system may include a plurality of nodes, a plurality of server devices, and a plurality of communication networks.

The anomaly detection model is a model for determining whether an anomaly has occurred in the first system. The anomaly detection model may be, for example, a machine learning model configured to receive, as input, a plurality of measurement values measured by one or more devices included in the first system and output the degree of an anomaly in the first system (anomaly score). The anomaly detection model may be trained in advance based on measurement values obtained in a normal state or measurement values obtained when an anomaly has occurred. The control unit can determine that some anomaly has occurred in the first system based on the anomaly score.

The control unit presumes whether the anomaly determined by the anomaly detection model is influenced by a failure in an external system connected to the first system. For example, when the first system is connected to a cellular communication network or a cloud server that provides calculation resources, the anomaly detection model may make anomaly determination due to a failure in such an external system.

The control unit may acquire failure information indicating a notification about a failure in a communication network or a server device included in the external system. The failure information may include information indicating a notification about a failure in a communication network or a server device that is not under the management responsibility of an administrator of the information processing device. When the failure information is acquired, the control unit may presume that the determined anomaly is influenced by the external system.

The control unit may update the anomaly detection model based on the acquired failure information. The control unit may update the anomaly detection model so that, for example, a known failure in the external system is excluded from the anomaly determination target. For example, the control unit may update the anomaly detection model so that the anomaly detection model no longer outputs an anomaly score exceeding a threshold due to the failure in the external system.

With this configuration, the failure in the communication network or the server device that is not included in the first system can be excluded from the anomaly determination target. Thus, it is possible to continue monitoring only the first system even if the failure has occurred in the external system.

The control unit may determine, based on the failure information, a time period in which the failure has occurred in the external system. Input and output of the anomaly detection model in the time period may be analyzed to identify the measurement value with a degree of contribution equal to or higher than a predetermined value to a change in the anomaly score due to the failure in the external system. For example, there is a technology for calculating the degree of contribution of input data to output data by analyzing the input data and the output data for the machine learning model. By executing this technology for the time period in which the failure has occurred in the external system, it is possible to identify the “measurement value correlated to the failure in the external system”.

For example, to suppress the anomaly determination due to the failure in the external system, there is a method for reducing a weight for the identified measurement value. Therefore, the control unit may perform correction to reduce the weight for the measurement value with the degree of contribution exceeding the predetermined value. Thus, it is possible to suppress the output of the anomaly score exceeding the threshold from the anomaly detection model due to the failure in the external system. That is, it is possible to suppress the continuation of the anomaly determination due to the known failure that is currently occurring, and to prepare for the occurrence of other failures.

Specific embodiments of the present disclosure will be described below with reference to the drawings. The hardware configuration, module configuration, functional configuration, etc. described in relation to the embodiments are not intended to limit the technical scope of the disclosure unless specifically stated otherwise.

### First Embodiment

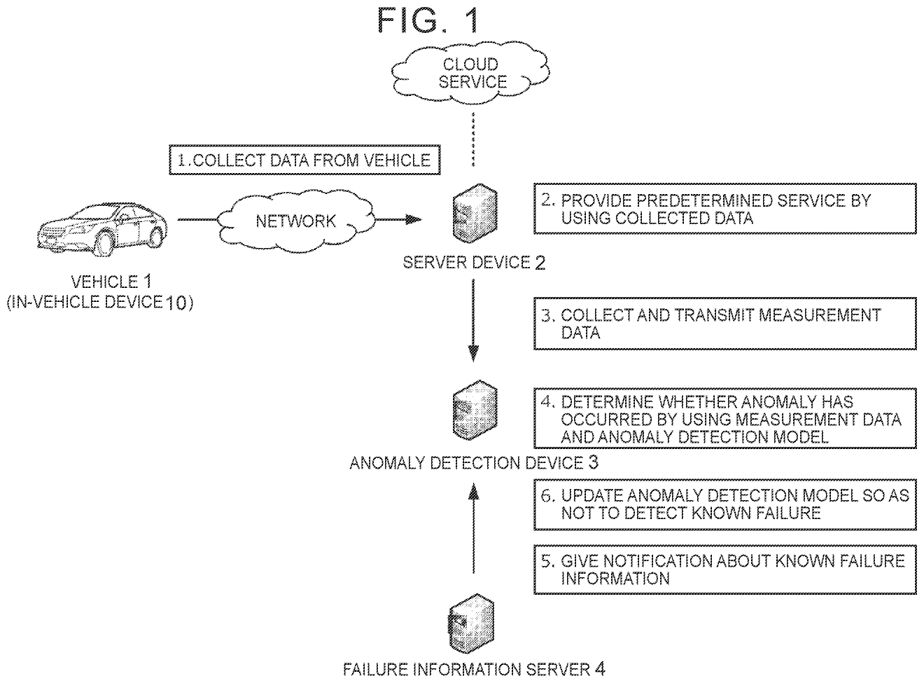

An overview of a data collection system according to a first embodiment will be described with reference to FIG. 1. The data collection system according to the present embodiment includes a vehicle 1 including an in-vehicle device 10, a server device 2, and an anomaly detection device 3. The data collection system may include a plurality of vehicles 1 (and in-vehicle devices 10) and a plurality of server devices 2.

The vehicle 1 is a probe vehicle for acquiring data. The vehicle 1 may be autonomous vehicle. The vehicle 1 is configured to acquire data while traveling, and can transmit the acquired data to the server device 2 via the in-vehicle device 10. Examples of the data acquired by the vehicle 1 include a vehicle speed, a traveling direction, position information, information on driving operations, information on vehicle behavior, and image data captured by an in-vehicle camera. In the following description, the data acquired by the vehicle 1 will be referred to as “sensor data”. The data acquired by the vehicle 1 need not essentially be data obtained by sensing.

The server device 2 provides predetermined services based on the sensor data collected from the vehicle 1. For example, traffic jam information and traffic information can be generated by collecting pieces of position information and speed information from a plurality of vehicles 1 and provided to other vehicles. Further, road map data can be generated by collecting images captured by in-vehicle cameras. The server device 2 requests the vehicles 1 to transmit predetermined sensor data, and the vehicles 1 (in-vehicle devices 10) transmit the sensor data in response.

The server device 2 may provide services by itself, or may provide services by using an external service (such as a cloud service) that provides additional calculation resources.

The server device 2 may provide a service to the vehicle 1 (or another vehicle) based on the sensor data collected from the vehicle 1, or may provide the sensor data collected from the vehicle 1 to an external device. For example, in a case where a plurality of types of sensor data is collected from the vehicle 1, the server device 2 may provide each type of sensor data to different external devices managed by different business operators.

The server device 2 is configured to acquire data on the status of data collection and processing (hereinafter referred to as “measurement data”). The measurement data includes one or more measurement values indicating the status of a device or network involved in sensor data collection and processing. The measurement value may be a value related to a network status (e.g., latency) or a value related to a hardware status (e.g., processor usage). In the present embodiment, the server device 2 is a single device, but may include a plurality of devices (including a virtual machine). In this case, the measurement data may include a value measured by each of the devices. The measurement data is transmitted to the anomaly detection device 3.

The anomaly detection device 3 detects that some anomaly has occurred in the data collection system based on the measurement data transmitted from the server device 2. The anomaly detection device 3 can detect that an anomaly has occurred in the data collection system by using, for example, a machine learning model that receives a plurality of measurement values as input data and outputs a score indicating the degree of an anomaly (hereinafter referred to as “anomaly score”).

With such a configuration, it is possible to detect a failure in any part of the data collection system. However, simple anomaly determination based on measurement data may result in cases where an anomaly cannot be detected appropriately.

For example, it is assumed that the data collection system includes a plurality of systems and a failure has occurred in any one of the systems. When a failure has occurred in part of the systems but the function as a whole is maintained, the anomaly determination continues as long as the failure continues, and determination cannot be made about other new anomalies that may occur. When a failure has occurred in part of the data collection system that is not under the management responsibility of the administrator, such as the network or cloud service shown in FIG. 1, a problem arises in that the anomaly determination continues and an anomaly in the device under the management cannot be detected.

In the present embodiment, the anomaly detection device 3 acquires known failure information provided from the outside and updates the machine learning model as appropriate so that the known failure is no longer detected (or is less detectable). The failure information is provided by a failure information server 4. The failure information server 4 is a server device that provides information (failure information) on a failure that has occurred in part of the data collection system that is not under the management responsibility of the administrator, such as communication infrastructure (e.g., a cellular communication network). A specific method will be described later.

### Hardware Configurations

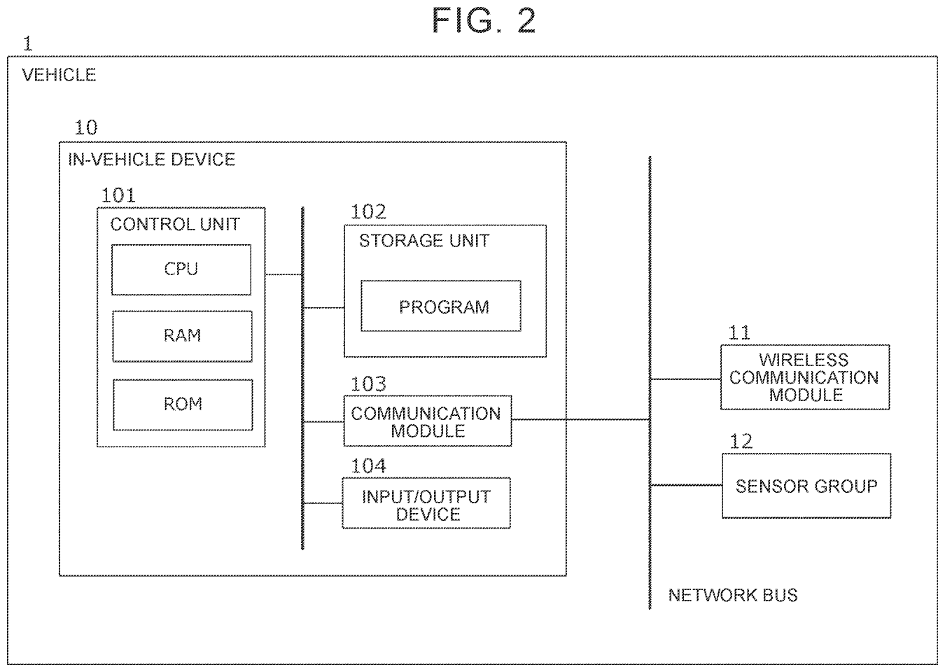

Next, the hardware configurations of the devices that constitute the system will be described. FIG. 2 schematically shows an example of the hardware configurations of the vehicle 1 and the in-vehicle device 10 according to the present embodiment. The vehicle 1 includes the in-vehicle device 10, a wireless communication module 11, and a sensor group 12.

The in-vehicle device 10 may be a computer including a processor (such as a central processing unit (CPU) and a graphics processing unit (GPU)), a main storage device (such as a random access memory (RAM) and a read only memory (ROM)), and an auxiliary storage device (such as an erasable programmable read only memory (EPROM), a hard disk drive, and a removable medium). The auxiliary storage device stores an operating system (OS), various programs, various tables, etc., and the stored programs are executed to implement functions (software modules) that fulfill predetermined purposes as described later. Some or all of the functions may be implemented as hardware modules by a hardware circuit such as an application-specific integrated circuit (ASIC) or a field-programmable gate array (FPGA). The in-vehicle device 10 is connected to a network bus of the vehicle 1.

The wireless communication module 11 is a communication device that performs wireless communication with other devices (or an external network) via a network. The wireless communication module 11 functions as a gateway that connects a component of the vehicle 1 to a network that is external to the vehicle. For example, the wireless communication module 11 provides access to an external network to the in-vehicle device 10. This allows the in-vehicle device 10 to communicate with external devices via the wireless communication module 11. The communication method used by the wireless communication module 11 may use a cellular communication network, or may use dedicated short-range communications (DSRC) or vehicle-to-vehicle communication. The communication method used by the wireless communication module 11 may be a method of performing communication over a relatively short distance using Wi-Fi (registered trademark) or Bluetooth (registered trademark).

The sensor group 12 is a group of a plurality of sensors of the vehicle 1. Examples of the sensors include a speed sensor, an acceleration sensor, and a global positioning system (GPS) module that acquire data on traveling of the vehicle. The sensors may be an image sensor, an illuminance sensor, and a rainfall sensor that acquire data on a traveling environment of the vehicle 1. The sensor group 12 may include a camera (image sensor) that captures an image of the surroundings of the vehicle.

The in-vehicle device 10 will be described in detail. The in-vehicle device 10 includes a control unit 101, a storage unit 102, a communication module 103, and an input/output device 104. The in-vehicle device 10 may be a device (e.g., a car navigation device) that provides information to an occupant of the vehicle.

The control unit 101 is an arithmetic unit that implements various functions of the in-vehicle device 10 by executing a predetermined program. The control unit 101 can be implemented by a hardware processor such as a CPU. The control unit 101 may include a RAM, a ROM, a cache memory, etc.

The storage unit 102 stores information, and is constituted by storage media such as a RAM, a magnetic disk, and a flash memory. The storage unit 102 stores programs to be executed by the control unit 101, data to be used by the programs, etc.

The communication module 103 is a communication interface that connects the in-vehicle device 10 to an in-vehicle network. The communication module 103 may include a network interface board that performs communication using, for example, a controller area network (CAN) protocol. The in-vehicle device 10 can communicate data with other components of the vehicle 1 via the communication module 103.

The input/output device 104 receives an input operation performed by an occupant of the vehicle, and presents information to the occupant. Specifically, the input/output device 104 includes input devices such as a mouse and a keyboard, and output devices such as a display and a speaker. The input/output device may be an integrated device such as a touch panel display.

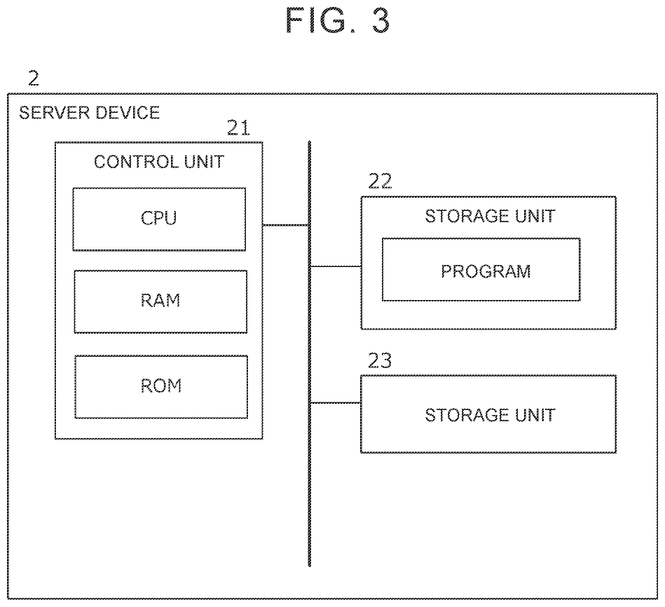

FIG. 3 schematically shows an example of the hardware configuration of the server device 2 according to the present embodiment. The server device 2 is a computer including a control unit 21, a storage unit 22, and a communication module 23.

As with the in-vehicle device 10, the server device 2 may be a computer including a processor (such as a CPU and a GPU), a main storage device (such as a RAM and a ROM), and an auxiliary storage device (such as an EPROM, a hard disk drive, and a removable medium). Some or all of the functions (software modules) may be implemented as hardware modules by a hardware circuit such as an ASIC or an FPGA.

The control unit 21 is an arithmetic unit that implements various functions (software modules) of the server device 2 by executing a predetermined program. The control unit 21 can be implemented by a hardware processor such as a CPU. The control unit 21 may include a RAM, a ROM, a cache memory, etc.

The storage unit 22 stores information, and is constituted by storage media such as a RAM, a magnetic disk, and a flash memory. The storage unit 22 stores programs to be executed by the control unit 21, data to be used by the programs, etc.

The communication module 23 is a communication interface that connects the server device 2 to a network. The communication module 23 may include, for example, a network interface board and a wireless communication interface for wireless communication. The server device 2 can communicate data with other computers via the communication module 23.

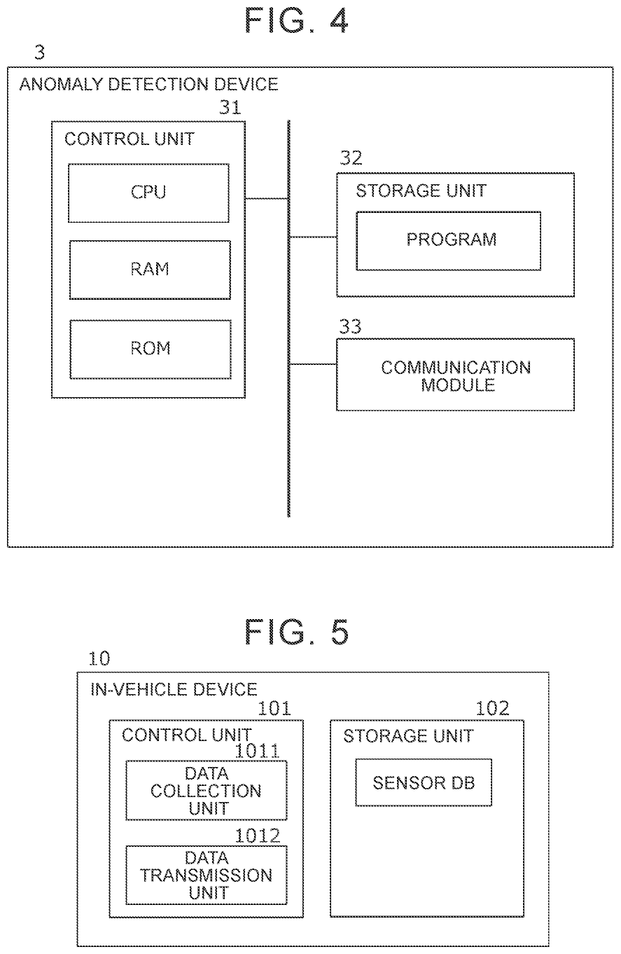

FIG. 4 schematically shows an example of the hardware configuration of the anomaly detection device 3 according to the present embodiment. The anomaly detection device 3 is a computer including a control unit 31, a storage unit 32, and a communication module 33. The configuration is the same as that of the control unit 21, the storage unit 22, and the communication module 23 of the server device 2. Therefore, detailed description thereof will be omitted.

In the specific hardware configurations of the in-vehicle device 10, the server device 2, and the anomaly detection device 3, components may be omitted, replaced, or added as appropriate depending on embodiments. For example, the control unit may include a plurality of hardware processors. The hardware processors may be constituted by a microprocessor, an FPGA, a GPU, etc. The input/output device may be omitted, or an input/output device (e.g., an optical drive) other than those given as examples may be added. The in-vehicle device 10, the server device 2, and the anomaly detection device 3 may be constituted by a plurality of computers. In this case, the hardware configurations of the computers may or may not coincide with each other.

The configurations shown in FIGS. 2 to 4 are illustrative, and all or some of the illustrated functions may be executed by using a specially designed circuit. The programs may be stored and executed by a combination of the main storage device and the auxiliary storage device other than those illustrated.

### Software Configurations

Next, the software configurations of the devices that constitute the system will be described. FIG. 5 schematically shows the software configuration of the in-vehicle device 10 according to the present embodiment.

In the present embodiment, the control unit 101 includes two software modules, namely a data collection unit 1011 and a data transmission unit 1012. The software modules may be implemented by the control unit 101 (CPU) executing the program stored in the storage unit 102. Information processing executed by the software modules is synonymous with information processing executed by the control unit 101 (CPU).

The data collection unit 1011 acquires sensor data from one or more sensors in the sensor group 12 at a predetermined timing, and stores it in a database (sensor DB) in the storage unit 102. When a plurality of pieces of sensor data can be acquired, the data collection unit 1011 may acquire all of them. The sensor DB is a database that stores pieces of sensor data collected from the sensors of the vehicle 1.

The data transmission unit 1012 transmits the sensor data stored in the sensor DB to the server device 2. The data transmission unit 1012 may transmit all the pieces of sensor data stored in the sensor DB to the server device 2, or may transmit only specific sensor data to the server device 2. For example, the data transmission unit 1012 may receive a request from the server device 2 and transmit only sensor data of a type specified by the request. Alternatively, the corresponding sensor data may be transmitted only when the user of the vehicle 1 agrees to transmit the data to the outside. The presence or absence of agreement may be stored in the storage unit 102. The sensor data may be transmitted periodically.

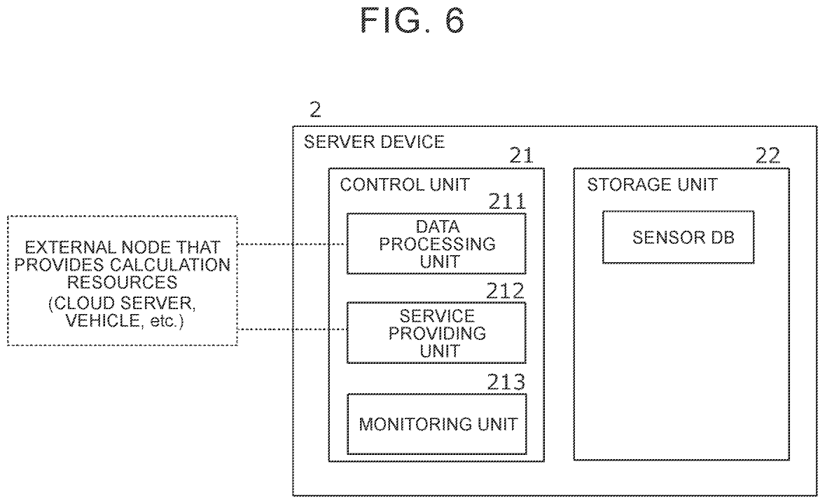

FIG. 6 schematically shows the software configuration of the server device 2 according to the present embodiment.

In the present embodiment, the control unit 21 of the server device 2 includes three software modules, namely a data processing unit 211, a service providing unit 212, and a monitoring unit 213. The software modules may be implemented by the control unit 21 (CPU) executing the program stored in the storage unit 22. Information processing executed by the software modules is synonymous with information processing executed by the control unit 21 (CPU).

Firstly, the data processing unit 211 requests each of the vehicles 1 (in-vehicle devices 10) to transmit sensor data. For example, when the server device 2 executes a service that generates road map data based on images captured by the vehicles 1, the data processing unit 211 requests each of the vehicles 1 to transmit image data. The type of sensor data requested by the data processing unit 211 may vary depending on the service executed by the server device 2. Secondly, the data processing unit 211 receives the pieces of sensor data from the vehicles 1 (in-vehicle devices 10) and stores them in the storage unit 22. The stored pieces of sensor data are used to provide a predetermined service.

The data processing unit 211 executes a predetermined process on the received pieces of sensor data to provide the predetermined service. Examples of the predetermined process include a process of analyzing data and a process of converting data.

The service providing unit 212 provides the predetermined service based on the pieces of data processed by the data processing unit 211. Examples of the predetermined service include a service that provides traffic information and a service that provides highly accurate road maps. For example, a three-dimensional road map can be generated by calculating the layout or shape of roads or buildings based on images captured by in-vehicle cameras. The service providing unit 212 may provide the generated data (e.g., road map data) to a predetermined vehicle (e.g., an autonomous vehicle that uses road map data).

In this example, the data processing unit 211 and the service providing unit 212 are each shown as a single module, but each module may be constituted by a plurality of entities. For example, the data processing unit 211 and the service providing unit 212 may implement the above processes through distributed processing using a plurality of nodes. In this case, the entity that performs calculation may be located outside the server device 2. For example, the data processing unit 211 and the service providing unit 212 may execute the above processes by using one or more cloud services that provide calculation resources such as a CPU, a memory, and a storage. A plurality of virtual containers may be provided at the nodes to execute the above processes. Examples of such a technology include Kubernetes (K8s).

Hereinafter, the entity that provides calculation resources will be referred to as “external node”. As described above, the calculation resources may be provided by the server device 2 or by the external node. The management responsibility of the administrator of the data collection system does not extend to the external node.

The monitoring unit 213 monitors the collection and processing of sensor data and the provision of services. Specifically, the monitoring unit 213 acquires one or more measurement values from entities associated with the data processing unit 211 and the service providing unit 212, that is, entities involved in the collection of sensor data and the provision of services. The target entity may be a node that provides calculation resources, or may be any other entity (e.g., a network device that connects the server device 2 and the vehicle 1). In a case where the calculation resources are provided by a cloud service, the target entity may be a device that manages the cloud service. The target entity may be a virtual entity.

The measurement value may be a value indicating a hardware resource, such as a usage of a CPU or a memory. The measurement value may be a value indicating network performance such as network latency, throughput, or a packet loss rate. The measurement value may be a value indicating performance in virtual hardware or a virtual network. The measurement value may be acquired at the application level. For example, in a case where data processing or service provision is executed by a plurality of applications, the measurement value may be a value indicating the performance of each application. For example, in a case where application containers are executed at a plurality of nodes, the measurement value may be acquired for each application container. The monitoring unit 213 generates data including the acquired measurement values (hereinafter referred to as “measurement data”).

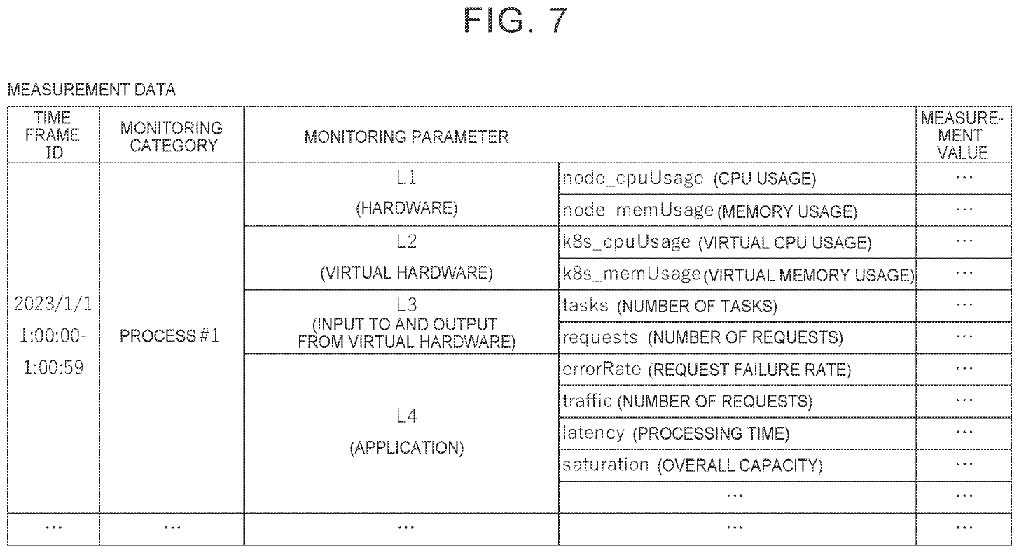

FIG. 7 shows an example of the measurement data. In the present embodiment, the measurement data is generated for each predetermined time frame (e.g., in units of one minute). The measurement data is generated for each monitoring category. The monitoring category is a unit of monitoring. For example, the processes to be executed by the data processing unit 211 and the service providing unit 212 may be divided into a plurality of blocks (processes #1, #2, #3, etc.), and different resources may be allocated to the blocks. In this case, the monitoring unit 213 generates the measurement data for each block as the monitoring category. The monitoring category is set as appropriate depending on the resource arrangement status.

The monitoring unit 213 acquires the measurement value for each of a plurality of monitoring parameters. Examples of the measurement value include a usage of a CPU or a memory, the number of tasks or requests input to virtual hardware, and a value measured at the application level (e.g., a processing time or a request failure rate). In the example of FIG. 7, the monitoring unit 213 acquires a plurality of monitoring parameters belonging to four layers L1 to L4. The generated measurement data is provided to the anomaly detection device 3 described later.

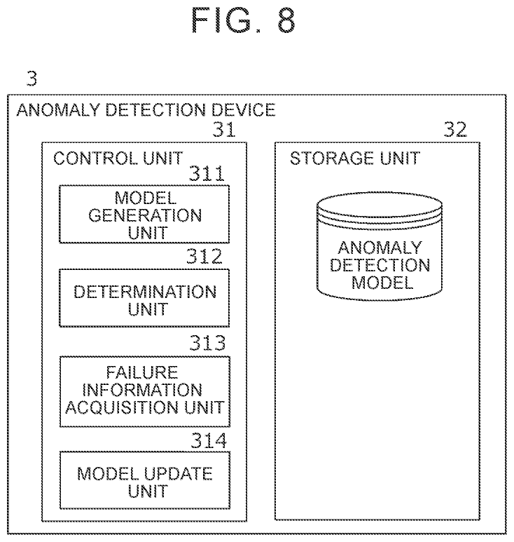

FIG. 8 schematically shows the software configuration of the anomaly detection device 3 according to the present embodiment.

In the present embodiment, the control unit 31 of the anomaly detection device 3 includes four software modules, namely a model generation unit 311, a determination unit 312, a failure information acquisition unit 313, and a model update unit 314. The software modules may be implemented by the control unit 31 (CPU) executing the program stored in the storage unit 32. Information processing executed by the software modules is synonymous with information processing executed by the control unit 31 (CPU).

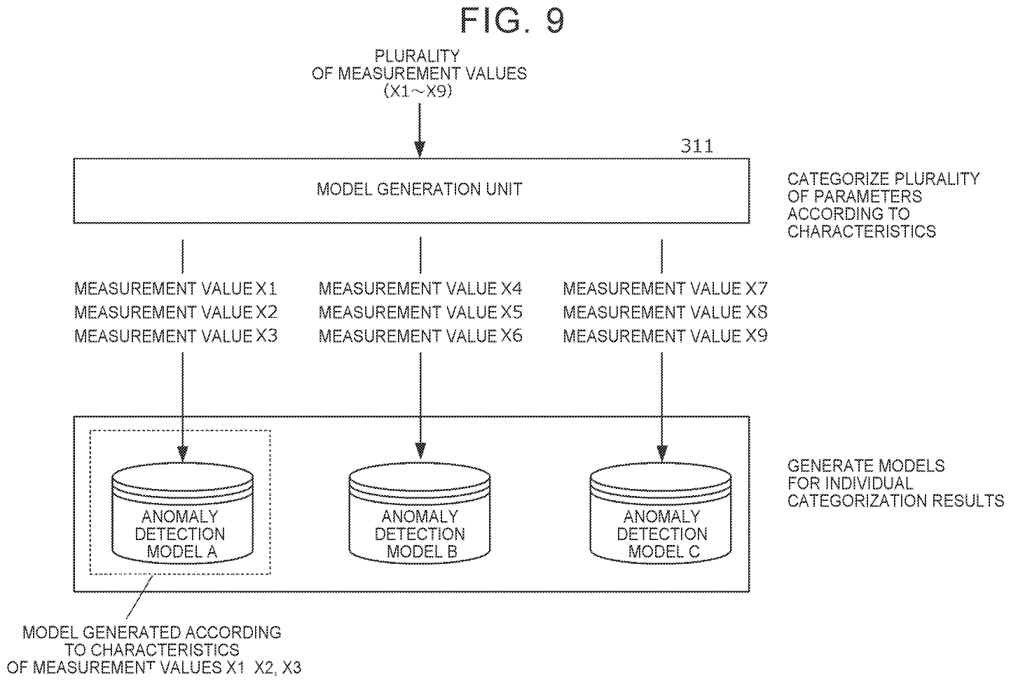

The model generation unit 311 generates a model for detecting an anomaly (anomaly detection model) based on measurement data acquired from the server device 2. FIG. 9 illustrates the generation of the anomaly detection model. As shown in the figure, in the present embodiment, the anomaly detection model includes a plurality of models.

The model generation unit 311 first categorizes measurement values collected in a predetermined period according to their characteristics. For example, the model generation unit 311 calculates statistics for the measurement values, and categorizes the measurement values based on the calculated statistics. Therefore, a plurality of measurement values having similar characteristics of statistics is categorized into the same group. Although the statistic is used as the criterion for categorization, any criterion may be used as long as measurement values having similar tendencies can be categorized into the same group. Examples of the method for categorization include cluster analysis.

The model generation unit 311 generates, for each obtained category, a machine learning model that receives measurement values as input data and outputs a score indicating the degree of an anomaly (anomaly score) as output data. In the illustrated example, the model generation unit 311 generates an anomaly detection model A by using three types of measurement values X1, X2, X3 as learning data. In other words, the generated anomaly detection model A is adapted to the characteristics of the measurement values X1, X2, X3. The learning data is composed of a set of measurement values and an anomaly score. The anomaly score in the learning data may be a score given empirically by the administrator based on the degree of an anomaly in the system when the measurement values were obtained. The learning optimizes the weights for input data (measurement values).

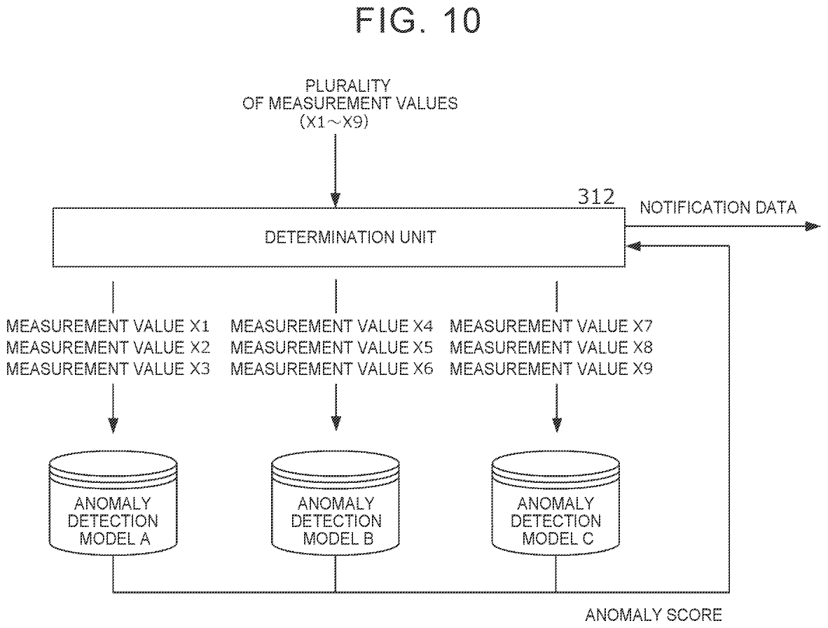

The determination unit 312 detects that some anomaly has occurred in the data collection system based on a plurality of anomaly detection models generated by the model generation unit 311 and measurement values acquired from the server device 2. FIG. 10 illustrates the operation of the determination unit 312.

The determination unit 312 categorizes the measurement values by using the same categorization criteria used by the model generation unit 311. The categorized measurement values are input into the corresponding anomaly detection models. Therefore, anomaly scores can be obtained as outputs from the respective models. When any anomaly detection model has output an anomaly score exceeding a threshold, the determination unit 312 outputs data for notification about an anomaly (notification data) to a predetermined device (e.g., a terminal associated with the system administrator). The determination unit 312 may presume the cause based on the anomaly detection model that has output the anomaly score exceeding the threshold, the types of the measurement values input to the anomaly detection model, etc. For example, when a certain anomaly detection model has output an anomaly score exceeding the threshold, it can be presumed that the measurement target hardware has trouble because there is an anomaly in the measurement value input to the model. For example, when the number of packets on a specific network interface has abruptly decreased, it can be presumed that the network connecting the vehicle 1 and the server device 2 has a failure. When the throughput of a storage device of a specific node has decreased, it can be presumed that a disk failure etc. has occurred. When any measurement value is missing, it can be presumed that the monitoring service (monitoring unit 213) is not operating normally. The determination unit 312 may transmit the notification data to a predetermined device.

The failure information acquisition unit 313 acquires failure information on a device or a network from an external system that is not managed by the administrator of the data collection system (hereinafter referred to as “unmanaged system”). For example, the failure information is provided by the failure information server 4. The cellular communication network used to connect the vehicle 1 and the server device 2 is an example of the unmanaged system. When the server device 2 obtains calculation resources from a cloud service rather than itself, the cloud service is an example of the unmanaged system. The failure information is notification information indicating that a failure (e.g., a network failure or a hardware failure) has occurred in the unmanaged system. The failure information acquired by the failure information acquisition unit 313 is transmitted to the model update unit 314.

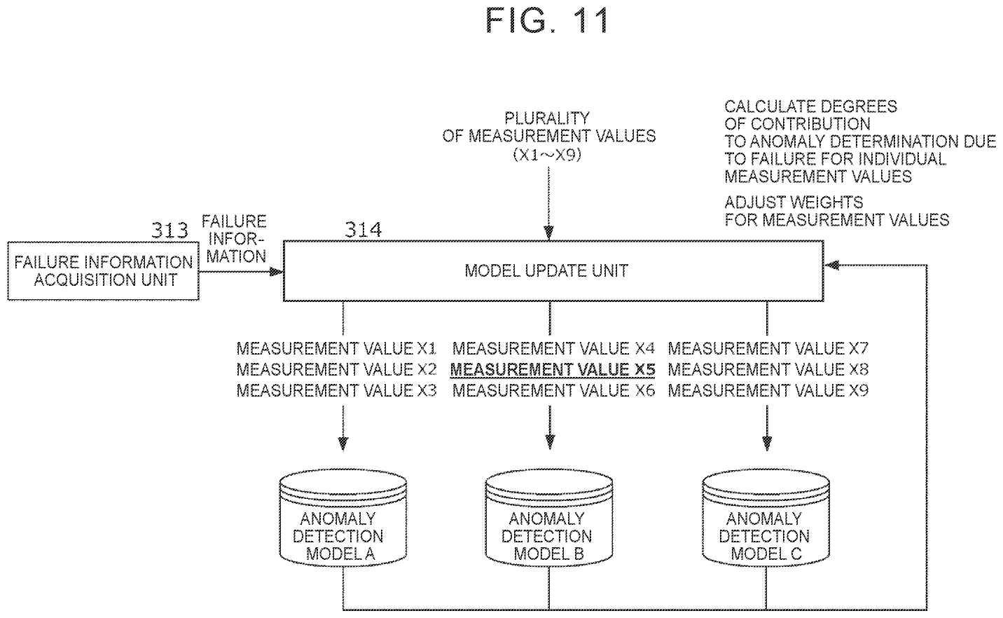

When a failure has occurred in the unmanaged system, the model update unit 314 updates the anomaly detection model to suppress anomaly determination caused by the failure. This operation will be described with reference to FIG. 11. For example, it is assumed that the failure has occurred in the unmanaged system and, as a result, a measurement value X5 among nine measurement values X1 to X9 deviates from the normal range. In this case, an anomaly detection model B outputs an anomaly score exceeding the threshold, and the determination unit 312 makes anomaly determination. Even if the failure that has occurred is known and the data collection system continues to operate, the anomaly determination continues unless the measurement value X5 returns to a normal value. In the present embodiment, when the failure has occurred in the unmanaged system, the model update unit 314 identifies the measurement value (X5) that is the cause of the anomaly determination, and corrects the weight for the measurement value to a smaller value, thereby suppressing the anomaly determination caused by the known failure.

Specifically, the model update unit 314 calculates the degree of contribution to a change in the anomaly score due to the failure for each of the measurement values. For example, there is a technology for calculating the degree of contribution of an input that influences an output in a machine learning model. Examples of such a technology include SHapley Additive exPlanations (SHAP). Therefore, when the anomaly score exceeding the threshold is output, it is possible to identify the factor (measurement value) that influences the anomaly score.

It is assumed that a notification of certain failure information is given and an anomaly is observed before and after the occurrence of the failure. The model update unit 314 uses a method such as SHAP to calculate the degree of contribution of the measurement value to the anomaly for each of the measurement values. A measurement value with a high degree of contribution (X5 in this example) is identified, and the anomaly detection model B is updated so that the weight for the measurement value is reduced. Therefore, it is possible to suppress the continuation of the anomaly determination due to the known failure. Description has been given of the example in which the weight for a specific measurement value is simply reduced. However, the weight for the specific measurement value may be adjusted to become relatively smaller than the other measurement values to reduce the influence of the identified measurement value on the output.

### Flowcharts

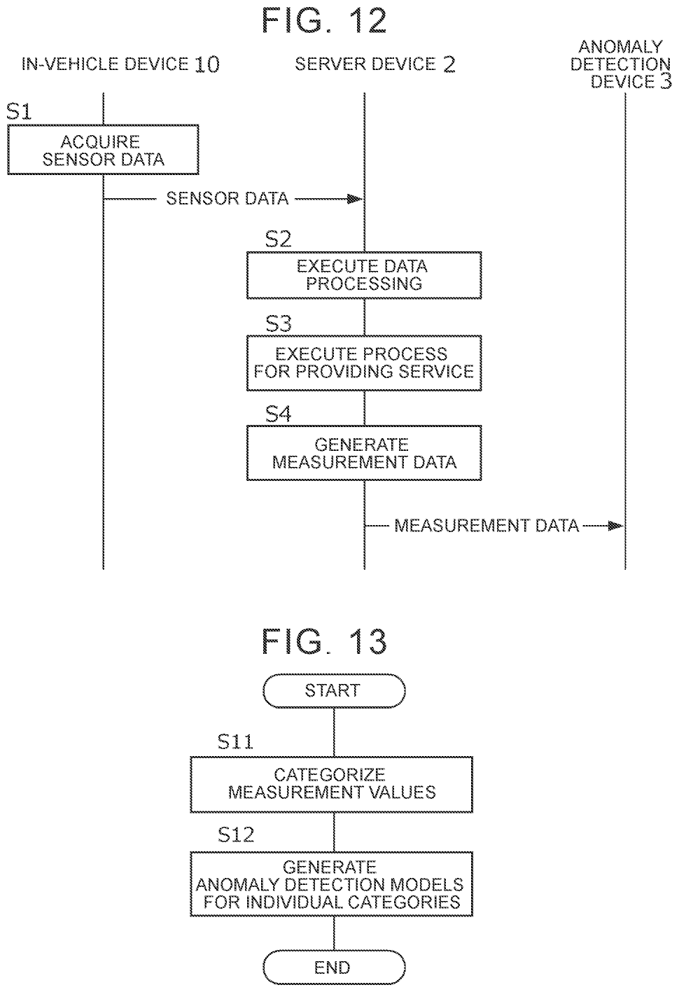

Next, details of processes to be performed by the in-vehicle device 10, the server device 2, and the anomaly detection device 3 will be described. FIG. 12 shows a flow of a process in which the in-vehicle device 10 transmits sensor data to the server device 2 and the server device 2 provides a service, and a process in which the server device 2 generates measurement data and provides it to the anomaly detection device 3.

In step S1, the in-vehicle device 10 (data transmission unit 1012) first transmits sensor data stored in the sensor DB to the server device 2 (data processing unit 211). Prior to this, the server device 2 may specify the type of sensor data to be requested, the date and time of acquisition, the location of acquisition, etc. for the in-vehicle device 10. The server device 2 may execute in advance a step of acquiring agreement to transmit sensor data from the driver of the vehicle 1.

When the server device 2 receives the sensor data, the server device 2 (data processing unit 211) executes predetermined data processing on the received sensor data in step S2. The data processing may be executed while being divided into a plurality of blocks. The blocks can be executed in parallel or sequentially. The data processing unit 211 may execute the data processing by using an external service (e.g., a cloud service). In this case, distributed processing may be performed by a plurality of nodes. For example, a data processing request may be issued to in-vehicle devices mounted on a plurality of vehicles constituting a traveling vehicle group, and the results may be obtained.

In step S3, the server device 2 (service providing unit 212) executes a predetermined process for providing the service. In this step, the process may be divided into a plurality of blocks as in step S2. The service providing unit 212 may execute the process by using an external service (e.g., a cloud service). In this case, distributed processing may be performed by a plurality of nodes.

In step S4, the server device 2 (monitoring unit 213) generates measurement data. In this step, the monitoring unit 213 acquires one or more measurement values from entities involved in data collection, data processing, and service provision, and generates measurement data illustrated in FIG. 7. The generated measurement data is transmitted to the anomaly detection device 3.

As described above, the anomaly detection device 3 executes three types of process, namely (1) a process of generating anomaly detection models by the model generation unit 311, (2) the process of detecting an anomaly by the determination unit 312, and (3) the process of updating an anomaly detection model by the model update unit 314. Details of each process will be described.

FIG. 13 is a flowchart of the process to be executed by the model generation unit 311 to generate anomaly detection models. The illustrated process is executed at a timing when a sufficient amount of measurement values has been accumulated to generate anomaly detection models. In step S11, a plurality of measurement values to be used for model generation is first categorized. For example, the model generation unit 311 calculates statistics for the measurement values, and categorizes the measurement values based on the calculated statistics by a method such as cluster analysis. Therefore, a plurality of measurement values having similar statistics is categorized into the same group.

In step S12, the model generation unit 311 generates an anomaly detection model by using the measurement values in each category as learning data. The learning data also includes a score indicating the degree of an anomaly in the system when the measurement values were obtained. Therefore, as many anomaly detection models as the generated categories are generated. The generated anomaly detection models are stored in the storage unit 32.

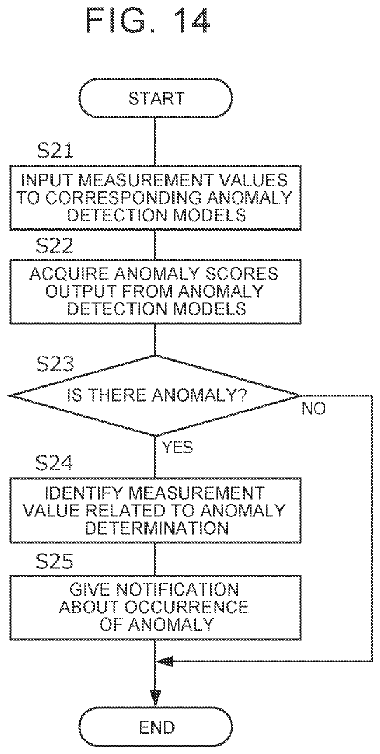

Next, the process in which the determination unit 312 detects an anomaly by using the generated anomaly detection models will be described. FIG. 14 is a flowchart of this process. The illustrated process is periodically executed in a situation where the generation of the anomaly detection models is completed. It is assumed that the measurement value acquisition is executed in the background separately from the flowchart.

In step S21, a plurality of acquired measurement values is first input to the anomaly detection models. As described above, in the present embodiment, a plurality of anomaly detection models is generated according to the characteristics of the measurement values. In this step, the acquired measurement values are categorized based on the same categorization criteria as those used in step S11, and are input to the corresponding anomaly detection model for each category.

In step S22, anomaly scores output from the anomaly detection models are acquired. In step S23, determination is made as to whether any anomaly detection model has output an anomaly score exceeding the threshold. When any anomaly detection model has output an anomaly score exceeding the threshold, affirmative determination is made in this step, and the process proceeds to step S24. When no anomaly detection model has output an anomaly score exceeding the threshold, the process is terminated.

In step S24, a measurement value related to the current anomaly determination is identified. As described above, there is a technology for calculating the degree of contribution of an input that influences an output in the field of machine learning. For example, the input (i.e., measurement value) that influences the output (i.e., the anomaly score exceeding the threshold) can be identified by using the above method such as SHAP. In this step, for example, the degrees of contribution of the inputs to the outputs may be acquired, and a measurement value with the degree of contribution exceeding a threshold may be presumed to be the cause of the anomaly determination. When the anomaly determination is made, data indicating the anomaly determination is transmitted to a predetermined device (e.g., a user interface device) in step S25. The data may include information on the type of anomaly and the measurement value presumed to be the cause.

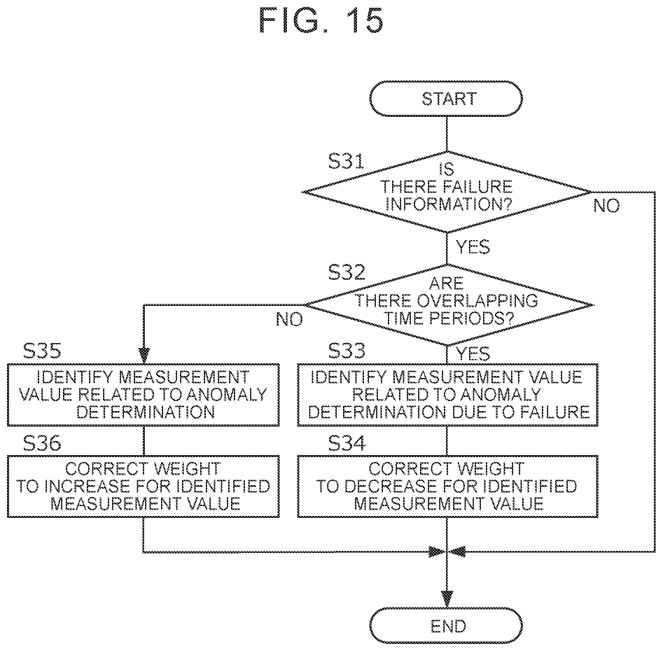

Next, the process to be executed when a failure has occurred in the unmanaged system will be described. As described above, when the failure has occurred in the unmanaged system, the determination unit 312 makes anomaly determination due to the failure. In the present embodiment, the model update unit 314 addresses such a case by updating the anomaly detection model. FIG. 15 is a flowchart of the process to be executed by the model update unit 314. The illustrated process is started when the determination unit 312 makes the anomaly determination.

In step S31, determination is first made as to whether failure information associated with the unmanaged system is currently present. When a failure has occurred in the unmanaged system and the determination unit 312 has made the anomaly determination, it is preferable to update the anomaly detection model so that the anomaly determination no longer continues.

When a failure has occurred in the unmanaged system, the process proceeds to step S32. When no failure has occurred in the unmanaged system, the process is terminated.

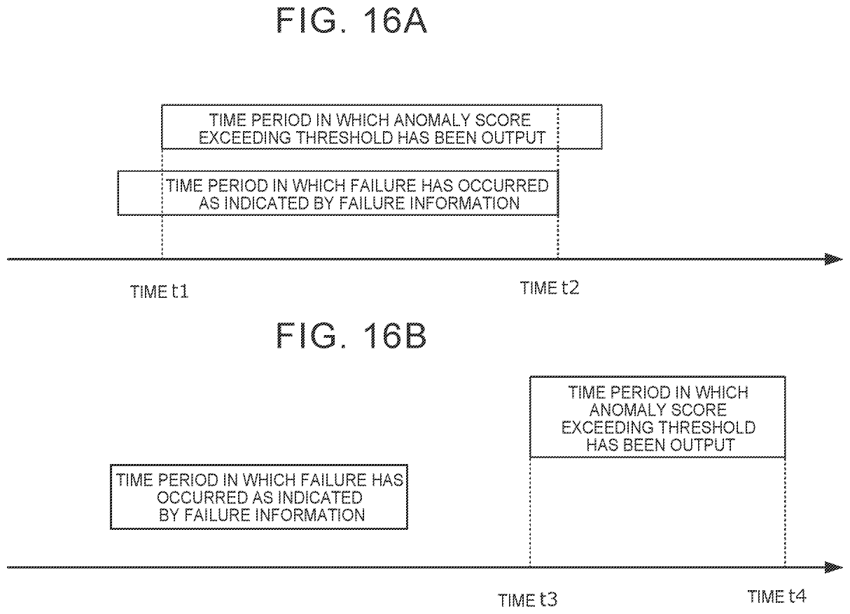

In step S32, determination is made as to whether the time period in which the anomaly determination is made overlaps the time period in which the failure has occurred as indicated by the failure information. When there are overlapping time periods, it can be presumed that the cause of the anomaly determination in the time periods is the failure in the unmanaged system. In an example of FIG. 16A, it can be presumed that the cause of anomaly determination made between time t1 and time t2 is a failure that has occurred in the unmanaged system. In this case, the process proceeds to step S33.

In step S33, a measurement value that is the cause of the anomaly determination due to the failure in the unmanaged system is identified. In this step, a measurement value with the degree of contribution equal to or higher than a predetermined value to the output is identified by analyzing the input and output of the anomaly detection model in the time period of determination. It can be presumed that a measurement value with the degree of contribution exceeding the predetermined value is the cause of the anomaly determination.

The measurement value that is the cause of the anomaly determination may be narrowed down to some extent based on the failure information. For example, when a hardware failure has occurred in a specific server device, it is clear that measurement values obtained in an unrelated device are not the cause of the anomaly determination. In such a case, the corresponding measurement values may be excluded in advance.

In step S34, the corresponding anomaly detection model is updated to correct the weight of anomaly determination to decrease for the measurement value identified in step S33. The weight may be set smaller for a measurement value with a higher degree of contribution. The weight may be corrected only for a measurement value generated during the overlapping time periods (from time t1 to time t2). Thus, it is possible to reduce the anomaly score due to the failure currently occurring in the unmanaged system.

In this step, the weight is reduced as the measurement value has a higher degree of contribution. Conversely, the weight may be increased as the measurement value has a lower degree of contribution.

When determination is made in step S32 that there are no overlapping time periods, it is presumed that the cause of the anomaly determination is not in the unmanaged system. In an example of FIG. 16B, it can be presumed that the cause of anomaly determination made between time t3 and time t4 is not in the unmanaged system. In this case, the process proceeds to step S35, and the degree of contribution to the output (anomaly score exceeding the threshold) is determined for each measurement value as in step S33. In this step, as in S24, the degrees of contribution of the inputs to the outputs (i.e., anomaly scores exceeding the threshold) can be acquired, and a measurement value with the degree of contribution exceeding the predetermined threshold can be presumed to be the cause of the anomaly determination.

In step S36, the corresponding anomaly detection model is updated to correct the weight of anomaly determination to increase for the measurement value identified in step S35. When there is a measurement value with the degree of contribution exceeding the threshold, this measurement value corresponds to an anomaly caused by a factor other than in the unmanaged system. Therefore, the weight is corrected to increase contrary to step S34. The weight may be set larger for a measurement value with a higher degree of contribution. The weight may be corrected only for the measurement value generated during the period from time t3 to time t4.

According to the processes described above, when anomaly determination is made due to a failure in the unmanaged system, the anomaly detection model can be updated so that the anomaly is less detectable. Therefore, the data collection system including a plurality of coexisting systems can attain an effect that an anomaly that has occurred in a system other than the system operated by itself is less detectable and an anomaly that has occurred in the system operated by itself is more detectable.

In the example of FIG. 15, the update of the anomaly detection model is started when a failure has occurred in the unmanaged system (step S31: Yes). When the failure in the unmanaged system is resolved, the anomaly detection model may be returned to the state before update.

### Modifications

The above embodiments are merely illustrative, and the present disclosure may be modified as appropriate without departing from the gist of the present disclosure. For example, the processes and the units described in relation to the present disclosure can be implemented in any combination unless any technical contradiction occurs.

The anomaly detection device 3 according to the embodiment updates the anomaly detection model based on the failure information in the unmanaged system. The anomaly detection device 3 may acquire information other than the failure information and update the anomaly detection model based on this information as long as the information serves as a notification that some event has occurred in the unmanaged system. Examples of the information other than the failure information include maintenance-related information (e.g., information indicating that available resources are temporarily reduced in a predetermined period).

A process described as being performed by a single device may be executed by a plurality of devices in cooperation. Alternatively, processes described as being performed by different devices may be executed by a single device. It is possible to flexibly change the hardware configuration (server configuration) to implement functions of a computer system.

The present disclosure can also be implemented by supplying a computer with a computer program that implements the functions described in relation to the above embodiments and causing one or more processors of the computer to read and execute the program. Such a computer program may be provided to the computer using a non-transitory computer-readable storage medium that is connectable to a system bus of the computer, or may be provided to the computer via a network. Examples of the non-transitory computer-readable storage medium include any type of disk or disc such as a magnetic disk (such as a floppy (registered trademark) disk and a hard disk drive (HDD)) and an optical disc (such as a compact disc read only memory (CD-ROM), a digital versatile disc (DVD), and a Blu-ray disc), a ROM, a RAM, an EPROM, an electrically erasable programmable read only memory (EEPROM), a magnetic card, a flash memory, an optical card, and any type of medium that is suitable to store electronic instructions.

What is claimed is:

1. An information processing device comprising a processor configured to:
determine, by using an anomaly detection model, whether an anomaly has occurred in a first system;
when determination is made that the anomaly has occurred in the first system, presume whether the anomaly is influenced by a failure in an external system connected to the first system; and
when presumption is made that the determined anomaly is influenced by the failure in the external system, update the anomaly detection model to reduce influence of the failure in the external system.

2. The information processing device according to claim 1, wherein the processor is configured to acquire failure information indicating a notification about a failure in a communication network or a server device included in the external system.

3. The information processing device according to claim 2, wherein the processor is configured to, when the failure information is acquired, presume that the anomaly is influenced by the external system.

4. The information processing device according to claim 2, wherein the external system is a system that is not managed by an administrator of the information processing device.

5. The information processing device according to claim 2, wherein:
the anomaly detection model is a machine learning model configured to receive, as input, a plurality of types of measurement values measured by one or more devices included in the first system and output an anomaly score of the first system; and
the processor is configured to, when the anomaly score exceeds a predetermined threshold, determine that the anomaly has occurred in the first system.

6. The information processing device according to claim 5, wherein the processor is configured to determine, based on the failure information, a time period in which the failure has occurred in the external system.

7. The information processing device according to claim 6, wherein the processor is configured to analyze input and output of the anomaly detection model in the time period such that the measurement value with a degree of contribution equal to or higher than a predetermined value to a change in the anomaly score is identified, the change in the anomaly score being due to the failure in the external system.

8. The information processing device according to claim 7, wherein the processor is configured to correct a weight associated with the identified measurement value for the anomaly detection model.

9. The information processing device according to claim 8, wherein the processor is configured to perform correction to reduce the weight for the measurement value with the degree of contribution exceeding the predetermined value.

10. An information processing method to be executed by an information processing device, the information processing method comprising:
determining, by using an anomaly detection model, whether an anomaly has occurred in a first system;
presuming, when determination is made that the anomaly has occurred in the first system, whether the anomaly is influenced by a failure in an external system connected to the first system; and
updating, when presumption is made that the determined anomaly is influenced by the failure in the external system, the anomaly detection model to reduce influence of the failure in the external system.

11. The information processing method according to claim 10, further comprising acquiring failure information indicating a notification about a failure in a communication network or a server device included in the external system.

12. The information processing method according to claim 11, wherein when the failure information is acquired, the presumption is made that the anomaly is influenced by the external system.

13. The information processing method according to claim 11, wherein the external system is a system that is not managed by an administrator of the information processing device.

14. The information processing method according to claim 11, wherein:
the anomaly detection model is a machine learning model configured to receive, as input, a plurality of types of measurement values measured by one or more devices included in the first system and output an anomaly score of the first system; and
when the anomaly score exceeds a predetermined threshold, the determination is made that the anomaly has occurred in the first system.

15. The information processing method according to claim 14, wherein a time period in which the failure has occurred in the external system is determined based on the failure information.

16. The information processing method according to claim 15, wherein input and output of the anomaly detection model in the time period are analyzed such that the measurement value with a degree of contribution equal to or higher than a predetermined value to a change in the anomaly score is identified, the change in the anomaly score being due to the failure in the external system.

17. The information processing method according to claim 16, wherein a weight associated with the identified measurement value is corrected for the anomaly detection model.

18. The information processing method according to claim 17, wherein correction is performed to reduce the weight for the measurement value with the degree of contribution exceeding the predetermined value.

19. A non-transitory storage medium storing instructions that are executable by one or more processors and that cause the one or more processors to perform functions comprising:
determining, by using an anomaly detection model, whether an anomaly has occurred in a first system;
presuming, when determination is made that the anomaly has occurred in the first system, whether the anomaly is influenced by a failure in an external system connected to the first system; and
updating, when presumption is made that the determined anomaly is influenced by the failure in the external system, the anomaly detection model to reduce influence of the failure in the external system.
